(19) United States
(12) Patent Application Publication
(10) Pub. No.: US 2010/0215864 A1
(43) Pub. Date: Aug. 26, 2010

(54) METHOD OF HIGH INTENSITY COOLING OF PERMEABLE BURNER BLOCK OF A FLAME SPRAY APPARATUS

(76) Inventor: Andrew Viatcheslavovich Baranovski, Glen Allen, VA (US)

Correspondence Address: Viatcheslav Baranovski, 12700 Stonebriar Lane, Richmond, VA, 23233, US

(21) Appl. No.: 12/390,497

(22) Filed: Feb. 22, 2009

(51) Int. Cl. B05D 1/08

(52) U.S. Cl. 427/446

(57) ABSTRACT

A method of forming a coating deposits a material onto a substrate with high-velocity thermal spray apparatus. The method comprises the steps of mixing of an oxidizer gas and a gaseous fuel in the mixing unit, igniting and combusting the oxidizer and gaseous fuel mixture in the permeable burner block to form products of combustion, feeding products of combustion to a discharge nozzle passage, introducing selected spraying material into the products of combustion to form a stream of particles that are accelerated and heated by the products of combustion in the nozzle; and applying liquid fuel to structural components of the permeable burner block for enhanced cooling of the structural components.

### BACKGROUND OF THE INVENTION

This invention relates in general to flame spray apparatus and to methods of deposition of coatings and bulk materials with thermal spray techniques. More specifically, the invention relates to high-velocity oxidizer-fuel spraying apparatus and methods.

Thermal spraying is widely used to apply metals and ceramics in a form of coating or bulk materials on different types of substrates. A majority of thermal spray methods utilize energy of hot gaseous jets to heat and accelerate particles of spraying material. When impinging the substrate, the particles form a coating.

High-Velocity Oxygen-Fuel (HVOF) spraying apparatus and techniques, which use oxygen as an oxidizer gas, generate a jet of hot gases due to combustion of a fuel and oxygen in an internal burner at elevated pressure, usually several bars. The fuel can be gaseous (e.g., propane, methane, propylene, MAPP gas (i.e., liquefied petroleum gas (LPG) mixed with methylacetylene-propadiene), hydrogen, etc.) or liquefied fuel (e.g., kerosene). From the burner, the gas expands into an exhaust nozzle, reaching sonic velocity. Further expansion in atmosphere or into wider section of the nozzle (e.g., in a De Laval nozzle) results in formation of a supersonic velocity jet. It is for this reason the technique is a “high-velocity” technique.

In spite of formation of rather dense coatings, the HVOF apparatus and techniques deposit materials with rather high oxide content as they melt the particles, at least partially, thus making the particle surface very active. Because the jets contain gaseous oxygen due to incomplete combustion and ejection of air from atmosphere, the particle molten surface oxidizes rapidly. Additionally, these apparatus and techniques are rather expensive due to large consumption of compressed oxygen. Further, clogging of the nozzle by molten spraying particles creates various problems in operation of HVOF apparatus.

High-Velocity Air-Fuel (HVAF) spraying apparatus and techniques use air or air enriched with oxygen as the oxidizer gas. HVAF apparatus were first created as a less-costly alternative to the HVOF apparatus. The combustion of air and kerosene is the main mode of operation. The main problem of such apparatus is unstable combustion at high flow rates of gases as flame propagation velocity in the fuel-air mixture is two orders of magnitude lower than in the fuel-oxygen mixture. Rather dimensional internal burners are used to stabilize and complete combustion. However, this prevents the possibility of introducing spraying powder axially into a chamber and nozzle because the chamber is too long for particles to travel through. Radial particle injection in the nozzle lowers the efficiency of particle heating because gas temperature in the nozzle is lower than in the combustion chamber and the high velocity of gas stream reduces dwell time of particles in hot jet, as they accelerate rapidly. As a result, spraying powder materials with higher melting points are being under heated, which makes their deposition efficiency (DE) very low. For example, typical DE for commercial tungsten carbide (WC) based powders is only 30-35%. The use of hydrogen to ignite the combustible mixture and as pilot flame in many HVAF guns makes them unpractical and unsafe.

Advancement in the HVAF apparatus included the introduction of a permeable burner block into the internal combustion chamber. The permeable block included a plurality of orifices constructed to transport combustible mixture of air and fuel gas (e.g., propane, propylene, natural gas, or MAPP gas) to a combustion region of the combustion unit. The permeable block is made of a ceramic material with low thermal conductivity. Generally, the flow rate through the burner block is several times larger than the backward flame propagation velocity. After ignition, the combustible mixture burns mainly on the downstream surface of the burner, and slightly inside orifices, with the flame at positions located adjacent to downstream surface of the burner. When heated over the auto-ignition temperature of the air-fuel mixture, multiple hot ignition centers on the downstream surface of the permeable burner block continuously ignite the mixture, thus making possible combustion in a rather small-size burner. The latter makes possible the injection of powder axially through the combustion chamber, which significantly improves particle heating and practically eliminates the possibility of nozzle clogging, since the particles are moving along jet axis, not touching the hot walls of the nozzle.

In spite of evident advantages, this advancement has disadvantages, such as the short life time of the ceramic permeable burner due to overheating and thermal stresses. The temperature of combustion depends on the air-to-fuel ratio. At higher combustion temperatures, which are needed for successfully spraying materials with higher melting points (e.g., tungsten carbide (WC) or chromium carbide (Cr₃C₂) based powders), the downstream surface of the burner and the walls of the holes in the burner experience an increase in internal temperature. This automatically increases preheating of the combustible mixture flowing through the burner, which in turn, increases the amount of energy released during combustion. This triggers a self-reinforcing reaction, that is, the more energy released due to increased pre-heating of the combustible mixture, the higher the pre-heating temperature. Eventually, the flame position moves deeper into the holes of the permeable burner until a flashback occurs and permanent damage is sustained by the permeable burner, as materials that can withstand direct heat of air-gas combustion (about 2,000° C.) and thermo-cycling during start up and stop operations are not readily available.

Another attempt to improve HVAF combustion stability and increase life time of internal burner included in advancement comprised of an oxidizer-fuel mixing assembly, a permeable burner block, an ignition device, an expanding nozzle and a spraying material delivering unit. In addition, the advancement comprises a catalytic member in the permeable burner block, which stabilizes combustion and makes it possible to lower the temperature of combustion of the air-gas fuel mixture. The catalytic member significantly lowers ignition temperature of the oxidizer-fuel mixture. It also adsorbs reactive gases on the surface of the catalyst providing a reaction (e.g., combustion) at lower temperatures at any concentration of the gases. Lower combustion temperatures increase the life time of the permeable burner block. However, catalysts can be successfully used primarily for spraying materials with low melting points. For example, known catalysts have maximum operating temperatures typically below 1,370° C., while gas temperatures in 1,950° C. to 2050° C. range are still needed for successful spraying of such widely used materials as tungsten carbide (WC) based and chromium carbide (Cr₃C₂) based powders.

### SUMMARY OF THE INVENTION

The present invention is related to a method of forming a coating by depositing a material onto a substrate with high-velocity thermal spray apparatus, wherein the apparatus comprises a mixing unit, a permeable burner block, a discharge nozzle passage, and a high velocity nozzle. The method comprises the steps of mixing of an oxidizer gas and a gaseous fuel in the mixing unit, igniting and combusting the oxidizer and gaseous fuel mixture in the permeable burner block, feeding products of combustion to a discharge nozzle passage to form products of combustion, introducing selected spraying material into the nozzle to form a stream of particles that are accelerated and heated by the nozzle; and applying liquid fuel to structural components of the permeable burner block for enhanced cooling of the structural components.

Various advantages of this invention will become apparent to those skilled in the art from the following detailed description of the preferred embodiment, when read in light of the accompanying drawings.

### BRIEF DESCRIPTION OF THE DRAWINGS

FIG. 1 is a vertical, longitudinal sectional view of an improved flame spray apparatus or device forming a preferred embodiment of the invention.

FIG. 2 is a vertical, longitudinal sectional view of an improved flame spray apparatus or device forming another preferred embodiment of the invention.

### DETAILED DESCRIPTION OF THE PREFERRED EMBODIMENT

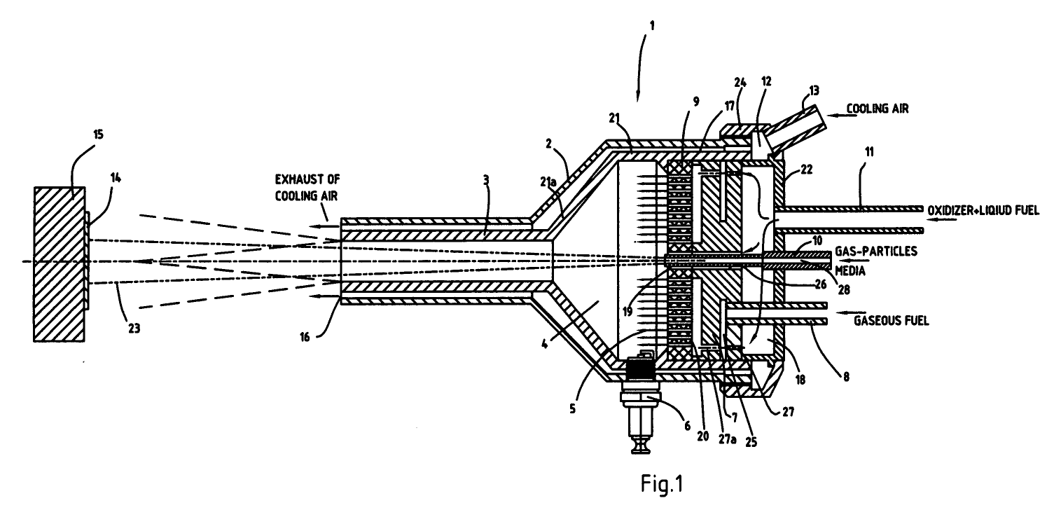

Referring now to the drawings, there is illustrated in FIG. 1 a flame spray apparatus or device, indicated generally at 1, comprising a cylindrical body piece 2, within which a combustion unit 21 with a gas discharging nozzle 3 is installed. A passage 17 for cooling air flow is formed between the cylindrical body piece 2 and the combustion unit 21. A permeable burner block 9 with a mixing unit 7 is installed in the combustion unit 21, and is held in place by a rear housing 22 and a retaining nut 24. An annular or toroidal cavity 12 defined by the retaining nut 24 and an outer cylindrical surface of the rear housing 22 may function to evenly distribute cooling compressed air introduced through a nipple 13. Cooling air passes from the cavity 12 through the passage 17 and exhausts into atmosphere through a cooling air exhaust exit 16.

The directional arrow labeled “OXIDIZER+LIQUID FUEL” constitutes a source of an oxidizer and a liquid fuel, preferably kerosene, or a mixture of liquid fuels. For demonstration purposes, liquid fuel, such as kerosene, and mixtures of liquid fuels will further be referred as liquid fuel. Liquid fuel is typically atomized by some external device (not shown) and may be supplied in an oxidizer in a form of a mist, or vaporized by some external vaporizer (not shown) and supplied in a form of vapors. The oxidizer-liquid-fuel mixture enters a distribution chamber 18, which may be defined at least in part by the rear housing 22, through a nipple 11. From this point, the oxidizer-liquid-fuel mixture passes through a first plurality of circumferentially spaced holes 27 into a mixing chamber 25 within the mixing unit 7. In this mixing chamber 25, the oxidizer and the liquid fuel mix up with a gaseous fuel, which is supplied to the mixing chamber 25 through a nipple 8. A formed oxidizer-liquid-fuel-gaseous-fuel combustible mixture, upon exiting a second plurality of circumferentially spaced holes 27a, passes through the permeable burner block 9, forming a high temperature flow 5 of the combustion products in a volume 4 of the combustion unit 21 upon igniting by a spark plug 6. This high-temperature flow 5 is directed by a forming block 21a into the discharge passage of the nozzle 3, where it accelerates to high velocity, such as a sonic velocity, if a cylindrical nozzle is used, or to supersonic velocity, if a De Laval nozzle is used.

The directional arrow labeled “GAS-PARTICLE MEDIA” constitutes a source of powder-carrier-gas media supplied from a separate powder feeder (not shown) through an inner powder injector 10. Powder particles, which are carried by a carrier gas, flow through an axial bore 28 of the inner powder injector 10. The inner powder injector 10 is inserted into a bore 26 of the mixing unit 7, forming a narrow annular path 19 for the oxidizer-liquid-fuel mixture, which cools the inner powder injector 10. Upon injection in hot combustion gases of the combustion unit 21, powder particles 23 are heated and accelerated by the products of combustion to high velocity in the discharge passage of the gas discharge nozzle 3, and form a coating 14 upon impact against work piece (e.g., substrate) 15.

Accordingly, small droplets of liquid fuel mist, passing through the permeable burner block 9, contact the upstream surface 20 of the permeable burner block 9 and are evaporated, providing intensive cooling of the permeable burner block 9, since, for example, latent heat of kerosene evaporation takes an additional 251 kJ/kg of heat out of permeable burner block 9. The amount of kerosene being fed into the device 1 may be adjusted in such a way that the temperature of the permeable burner block 9 stays high enough to provide multiple ignition centers and hence stable and sustained combustion on the downstream surface of the burner block 9, but lower than the maximal operating temperature of material of the permeable burner block 9. It should be understood by those skilled in the art that supplying liquid fuel into oxidizer changes the fuel-oxidizer ratio in the combustible mixture, and in order to provide the necessary combustion fuel-oxidizer ratio (close to stoichiometry), the amount of gaseous fuel fed into the permeable burner block 9 should be adjusted (e.g., reduced) in direct proportion to the amount of kerosene fed therein, since the total amount of oxidizer (e.g., compressed air) used for combustion remains the same. In fact, the liquid-fuel may contain gaseous-fuel from 0 to 100% by weight. It should be understood that higher liquid fuel content may provide better cooling of a permeable burner block 9, since such mixtures provide more liquid fuel to be evaporated on the surface of the permeable burner block 9.

Not only liquid fuel mist, but also liquid fuel vapors effectively lower the temperature of the permeable burner block 9. Liquid fuel vapors can be produced by some external kerosene vaporizing device (not shown). Liquid fuel vapors partially condense forming droplets upon being fed into a cold compressed oxidizer supplied via the nipple 11, as well as on a relatively cold upstream surface 20 of the permeable burner 9. The formed droplets evaporate later in the hot channels of the downstream part of the permeable burner block 9, thus cooling the burner block 9 and decreasing thermal stresses in the material of the block 9. Moreover, liquid fuel vapors themselves, even without being condensed, still provide additional cooling to the permeable burner block 9, due to the fact that, for instance, the kerosene heat transfer coefficient (i.e., 0.15 W/mK) is an order of magnitude greater than, for example, that of propane (i.e., 0.019-0.023 W/mK), which along with greater heat capacity (2.01 kJ/kg K for kerosene vs. 1.501 kJ/kg K for propane) significantly improves the cooling effect of the oxidizer-liquid-fuel-gaseous-fuel combustible mixture.

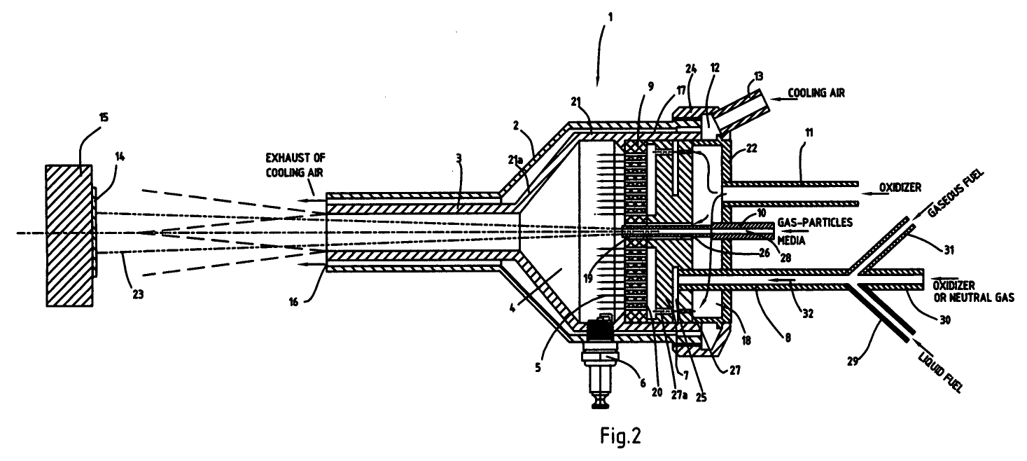

In another embodiment shown in FIG. 2, only oxidizer is supplied through the nipple 11. Gaseous fuel flow is supplied through the nipple 31. Liquid fuel is fed into gaseous fuel flow through an additional nipple 29. A mixture 32 of gaseous fuel and liquid fuel is then fed into mixing chamber 25 of the mixing unit 7, where it forms an oxidizer-liquid-fuel-gas-fuel mixture supplied to a permeable burner block 9. Since gaseous fuel flow in the HVAF process is significantly lower than air flow (usually a ratio is close to 25:1 by volume), the flow of gaseous fuel may be insufficient to carry the liquid fuel into the mixing chamber 25, especially if very high liquid-fuel content (close to 100%) is used. In this case an additional oxidizer or neutral gas flow may be supplied through a nipple 30 to carry liquid fuel into a mixing chamber 25.

In accordance with an exemplary embodiment, a coating is sprayed with an HVAF apparatus 1 comprising a permeable burner block 9 (as described with reference to FIG. 1). A permeable burner block 9 is made in the form of a porous cylindrical insert made of aluminum oxide (Al₂O₃), about 12% silicon dioxide (SiO₂) ceramic, having about 64% total porosity. The apparatus 1 is operated with air flow of about 85 liters per second, an inlet pressure of about 6.2 bar, and a propane flow of about 2.0 liters per second under a pressure of about 5.1 bar. A coating is applied using 5-30 μm particle size tungsten carbide-cobalt-chrome 86% WC-10% Co-4% Cr powder. Under these operating parameters, the apparatus is able to operate indefinitely (i.e., for a long time) without flashback and any damage to the perforated burner block 9. The mean hardness of the coating is measured at about 1,090 HV₃₀₀.

With the air flow increased to about 110 liters per second and the propane flow increased to about 2.6 liters per second, the output power of the permeable burner block 9 of the apparatus 1 is increased by approximately 30% over a regular limit for the burner block 9. Under these parameters, the apparatus 1 is able to operate for approximately 2 minutes, after which time flashback may occur, and the perforated burner block 9 may overheat and burn through, render a coating application impossible.

After this, the perforated burner block 9 is replaced with a new one, and the electrical kerosene vaporizing device is attached to the air line of the apparatus 1 to supply kerosene vapors in air flow. For ease of start up, the apparatus 1 is started with air and propane only. The same parameters when flashback occurred are used. Immediately after start up the propane flow was dropped to about 1.3 liters per second (i.e., about 2.6 grams per second), and simultaneously kerosene flow is increased in order to maintain the same stoichiometric air-fuel ratio to the point, where sustained and stable combustion of air-kerosene-propane mixture in the permeable burner block 9 is reached, which is achieved at about 2.4 grams per second (which corresponds to kerosene to fuel-gas ratio of 48:52 by weight). At this point, the apparatus 1 works for several hours with no signs of overheating, and without damaging the permeable burner block 9. A coating from the same 86% WC-10% Co-4% Cr powder is applied. The coating exhibits much higher hardness in the range of about 1,150-1,200 HV₃₀₀. This can be attributed to about 30% higher energy of the jet, which is achieved by increasing flows of oxidizer and fuel (since Higher Heating Values of kerosene, for example, 46.2 MJ/kg, and propane, for example, 50.35 MJ/kg, are practically the same, and partial or full replacement of propane with kerosene does not increase jet energy).

Thus, application of kerosene to the permeable burner block 9 significantly improves its cooling, allowing for a higher energy level to be generated in the jet without flashback and physical destruction of the burner block 9, which in turn significantly improves quality of applied coatings.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method of forming a coating by depositing a material onto a substrate with high-velocity thermal spray apparatus, wherein the apparatus comprises a mixing unit, a permeable burner block, a discharge nozzle passage, and a high velocity nozzle, the method comprising the steps of:
a) mixing of an oxidizer gas and a gaseous fuel in the mixing unit,
b) igniting and combusting the oxidizer and gaseous fuel mixture in the permeable burner block to form products of combustion,
c) feeding products of combustion to a discharge nozzle passage,
d) introducing selected spraying material into the products of combustion to form a stream of particles that are accelerated and heated by products of combustion in the discharge nozzle passage; and
e) applying liquid fuel to structural components of the permeable burner block for enhanced cooling of the structural components.

2. The method as claimed in claim 1 wherein the applying step comprises applying a mixture of liquid fuels to structural components of a permeable burner block.

3. The method as claimed in claim 2 wherein the applying step comprises the step of applying the mixture of liquid fuels at least in part in a form of a mist.

4. The method as claimed in claim 3 wherein the mixture of liquid fuels contains gaseous fuel from 0 to 100% by weight.

5. The method as claimed in claim 2 wherein the applying step comprises the step of applying the mixture of liquid fuels at least in part in a form of vapor.

6. The method as claimed in claim 5 wherein the mixture of liquid fuels contains gaseous fuel from 0 to 100% by weight.

7. The method as claimed in claim 2 wherein the mixture of liquid fuels contains gaseous fuel from 0 to 100% by weight.

8. The method as claimed in claim 1 wherein the applying step comprises applying kerosene to structural components of a permeable burner block.

9. The method as claimed in claim 8 wherein the kerosene applying step comprises the step of applying the kerosene at least in part in a form of mist.

10. The method as claimed in claim 9 wherein kerosene contains gaseous fuel from 0 to 100% by weight.

11. The method as claimed in claim 8 wherein the kerosene applying step comprises the step of applying the kerosene at least in part in a form of vapor.

12. The method as claimed in claim 11 wherein kerosene contains gaseous fuel from 0 to 100% by weight.

13. The method as claimed in claim 8 wherein kerosene contains gaseous fuel from 0 to 100% by weight.

14. The method as claimed in claim 1 wherein the applying step comprises the step of applying the liquid fuel at least in part in a form of mist.

15. The method as claimed in claim 14 wherein liquid fuel contains gaseous fuel from 0 to 100% by weight.

16. The method as claimed in claim 1 wherein the liquid fuel applying step comprises the step of applying the liquid fuel at least in part in a form of vapor.

17. The method as claimed in claim 16 wherein liquid fuel contains gaseous fuel from 0 to 100% by weight.

18. The method as claimed in claim 1 wherein liquid fuel contains gaseous fuel from 0 to 100% by weight.
